(19) United States
(12) Patent Application Publication
(10) Pub. No.: US 2024/0336447 A1
(43) Pub. Date: Oct. 10, 2024

(54) Loading Dock with Integrated Leveler

(71) Applicant: Leum Engineering, Inc. d/b/a Dockzilla Co., Minnetonka, MN (US)

(72) Inventors: Grant Leum, Excelsior, MN (US); Eric Demerath, Shepherd, MI (US)

(73) Assignee: Leum Engineering, Inc. d/b/a Dockzilla Co., Minnetonka, MN (US)

(21) Appl. No.: 18/130,727

(22) Filed: Apr. 4, 2023

Related U.S. Application Data
(63) Continuation-in-part of application No. 18/130,649, filed on Apr. 4, 2023.
Application No. 18/130,649 is a continuation-in-part of application No. 17/902,542, filed on Sep. 2, 2022.

(51) Int. Cl. B65G 69/28

(52) U.S. Cl. CPC B65G 69/2864; B65G 69/287

(57) ABSTRACT

A modular loading dock with a mobile base includes an adjustable front section with front opposing adjustable leg members and middle opposing adjustable leg members, two adjustable feet connect each front leg member to a middle leg member, as well as an adjustable back section connected to the adjustable front section and including opposing rear adjustable leg members each having a grade plate. The mobile base has top and bottom surfaces, the top surface has an opening to receive a dock leveler into such opening, the dock leveler includes a lower end and an upper end, the upper end abuts a preexisting structure and the lower end has a lower edge having a lip, the lip being able to be activated between an extended/engaged position to contact a truck bed and a retracted/disengaged position.

### RELATED APPLICATION

This application is a continuation-in-part claiming the benefit of application Ser. No. 18/130,649, filed earlier today, Apr. 4, 2023, which claims the benefit of application Ser. No. 17/902,542, filed on Sep. 2, 2022, the entire contents of which are incorporated herein.

### FIELD OF THE INVENTION

This invention relates to a loading dock and more particularly to a loading dock with a dock housing which is modular, easily moveable and able to adjust to the grade.

### BACKGROUND OF THE INVENTION

A variety of loading docks with dock housings have been devised which are constructed over docks built into buildings. Loading docks with dock housings protect the dock as well as provide shelter from the weather during loading and unloading of cargo onto trucks and the like.

One such device is seen in EP 3261964 (Fijnvandraat) which discloses a dock leveler with rolling cover. The cover is a light-weight aluminum cover. A similar device is disclosed in CN 104060857 which discloses a permanently built dock shelter structure with an adjustment plate and door seal.

Loading docks with dock housings of the prior art have certain shortcomings and disadvantages to which this device is drawn. Specifically, it would be advantageous to have a loading dock with a dock housing which is modular and able to be easily assembled and disassembled without the need for concrete construction. It would also be advantageous to have a loading dock with a dock housing which integrates conventional loading dock levelers. It would also be advantageous to have a loading dock with a dock housing which is mobile so as to allow the loading dock and dock housing to be moved easily from location to location and which can also conform to the grade.

In summary, there are problems and shortcomings in dock housings of the prior art and it is to these needs that this device is drawn.

### OBJECTS OF THE INVENTION

It is an object of this invention to provide a loading dock with a dock housing which is modular and able to be easily assembled and disassembled without the need for concrete construction and which can be easily adjustable to conform to the grade.

Another object of this invention is to provide such a loading dock with a dock housing which integrates conventional loading dock levelers.

Yet another object of this invention is to provide a loading dock with a dock housing which is able to be moved easily from one location to another location.

These and other objects of the invention will be apparent from the following descriptions and from the drawings.

### SUMMARY OF THE INVENTION

In a highly preferred embodiment of the present invention a modular loading dock includes a mobile base with an adjustable front section having front opposing adjustable leg members and middle opposing adjustable leg members; two adjustable feet connect each front leg member to a middle leg member; an adjustable back section is connected to the adjustable front section and includes opposing rear adjustable leg members each having a grade plate; and top and bottom surfaces. Preferably, the top surface has an opening to receive a dock leveler into the opening. The dock leveler includes a lower end and an upper end; the upper end abuts a preexisting structure and the lower end includes a lower edge having a lip, the lip is able to be activated between an extended/engaged position to contact a truck bed and a retracted/disengaged position in highly-preferred embodiments of the invention.

It is highly preferred that the at least two adjustable feet contact and conform to the grade and that the adjustable feet are able to be adjusted independently of each other. Preferably, the two adjustable feet are able to be adjusted between a left-side to right-side direction as well as adjustable in a front-to-back direction so as to allow the two adjustable feet to conform to the grade.

A preferred embodiment includes the opposing front and middle adjustable leg members at a distal end, each having one or more adjustment structures. The adjustment structures are connected to the adjustable feet and have an adjustable plate, locking bolt, a first locking nut and a second locking nut. The adjustable plate is secured to the support member by the locking bolt, first locking nut and second locking nut in preferred embodiments and the two opposing grade plates are able to be adjusted independently of each other. It is also preferable that a unitary support member is connected to each opposing front adjustable leg member, middle adjustable leg member and rear adjustable leg member.

Preferably, the mobile base is removable and able to be transported to different locations.

A highly preferred embodiment of the present invention is a modular loading dock with a mobile base including an adjustable front section having first opposing adjustable leg members and second opposing adjustable leg members. Preferably, each first and second leg member includes at least two adjustable feet, and each adjustable foot connects a first leg member to a second leg member. Highly-preferred embodiments include an adjustable back section is connected to the adjustable front section and includes opposing rear adjustable leg members and top and bottom surfaces. The top surface preferably has an opening to receive a dock leveler into the opening. The dock leveler includes a lower end and an upper end, the upper end abuts a preexisting structure and the lower end includes a lower edge having a lip, the lip is able to be activated between an extended/engaged position to contact a truck bed and a retracted/disengaged position in highly-preferred embodiments. The housing of the modular loading dock also includes a modular frame mounted onto the base in sections; the sections include a frame-front wall, opposed frame-sidewalls and a frame-top wall. Preferably, the frame-front wall has a vehicle-receiving opening to receive a back end of a vehicle and the modular frame includes a covering.

It is highly preferred that the covering is a tensioned vinyl covering and that flashing is integral to the tensioned vinyl covering.

In some preferred embodiments the housing is secured to a wall of a building. It is also preferable that the base and housing are removable and able to be transported to different locations.

The term Aimpactable@ as used herein refers to a base or frame which can withstand and transfer an impact load from a vehicle.

### BRIEF DESCRIPTION OF THE DRAWINGS

FIG. 1 is a perspective view of a modular loading dock;

FIG. 2 is a perspective view illustrating an adjustable leg member;

FIG. 3 is a sectional view of an adjustable leg member of FIG. 1 taken along line 3-3;

FIG. 4 is a side view of the base and housing;

FIG. 5 is a side view of the base and housing with the base adjusted to the grade;

FIG. 6 is a side view of the base;

FIG. 7 is a sectional view of an adjustable leg member of FIG. 6 taken along line 7-7;

FIG. 8 is a sectional view of the base of FIG. 6 taken along line 8-8;

FIG. 9 is a sectional view of the base of FIG. 6 taken along line 9-9;

FIG. 10 is an exploded view of the modular loading dock;

FIG. 11 is a perspective view of a modular loading dock;

FIG. 12 is a side view of the base of the modular loading dock of FIG. 11;

FIG. 13 is a sectional view of the base of FIG. 12 taken along line 13-13;

FIG. 14 is a side view of the base of FIG. 11 with the base adjusted to the grade; and

FIG. 15 is a perspective view of the base of FIG. 11 and housing.

### DETAILED DESCRIPTION OF PREFERRED EMBODIMENTS

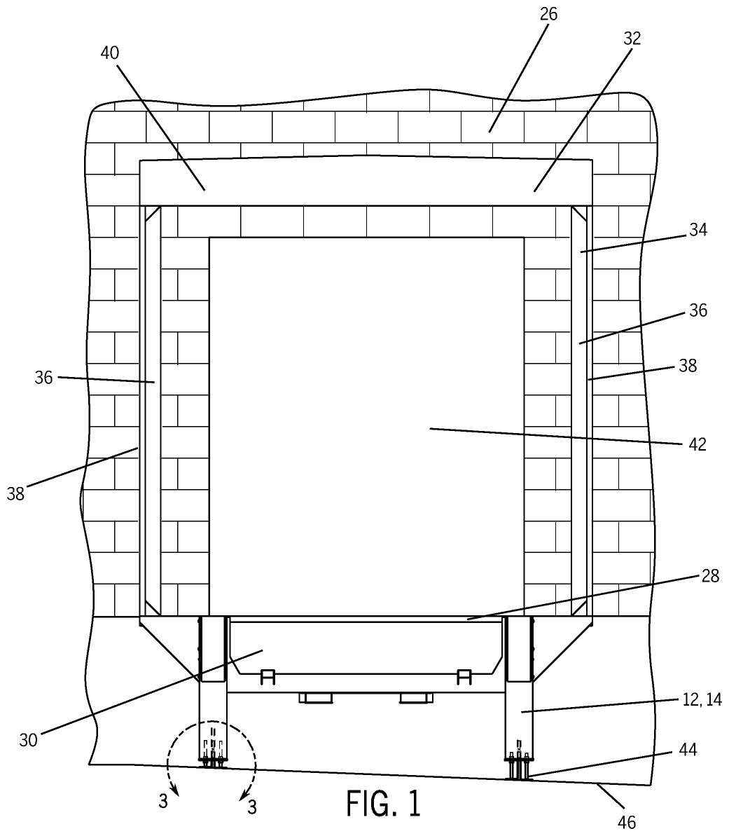

FIGS. 1-15 illustrate a modular loading dock 10 with a mobile base 12 and a housing 32 with a modular frame 34. Frame 34 is self-standing (it can operate as a stand-alone platform and does not need any other structure to function) but frame 34 is versatile as well as modular as it can also be used with any platform, ramp, dock housing or an existing building.

FIG. 1 illustrates that base 12 includes at least two but preferably four, opposing, adjustable leg members 14. Base 12 has both top and bottom surfaces 16, 18, with top surface 16 having an opening 20 to receive a dock leveler 58 into opening 20.

Housing 32 includes modular frame 34 which is mounted onto base 12 in sections, as seen in FIG. 1. These sections include a frame-front wall 36, opposed frame-sidewalls 38 and a frame-top wall 40. Frame-front wall 36 has a vehicle-receiving opening 42 to receive a back end of a vehicle as illustrated in FIG. 1.

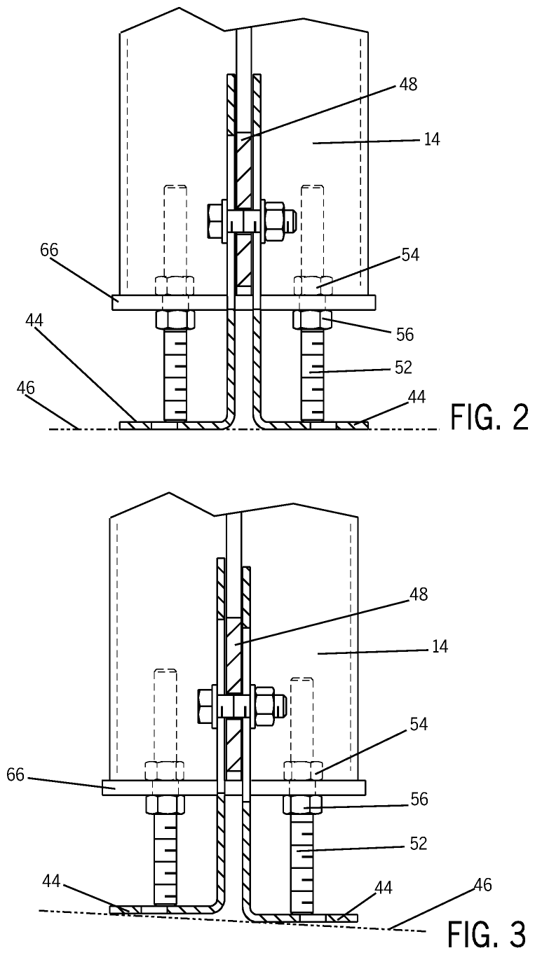

FIGS. 2-3 illustrate adjustable leg member 14 in detail and that adjustable leg member 14 includes at least two adjustable feet 44 on each adjustable leg member 14. Adjustable feet 44 are able to contact and conform to grade 46. FIG. 2 illustrates adjustable feet 44 contacting the grade 46 which is fairly level. FIG. 3 illustrates how adjustable feet 44 can conform to grade 46 when it is not level. As seen in FIG. 3, adjustable feet 44 are able to be adjusted independently of each other. In FIG. 3, the adjustable feet 44 shown are in different positions so as to securely contact the grade 46. Adjustable feet 44 are able to be adjusted between a left side to right side direction as well as adjustable in a front-to-back direction so as to allow each of the adjustable feet 44 to conform to grade 46.

FIGS. 2-3 illustrates that adjustable leg members 14 include one or more adjustment structures. The adjustment structures include a locking bolt 52, a first locking nut 54 and a second locking nut 56. When first locking nut 54 and second locking nut 56 are loosened, the height of adjustable feet 44 can be changed so as to closely conform to grade 46.

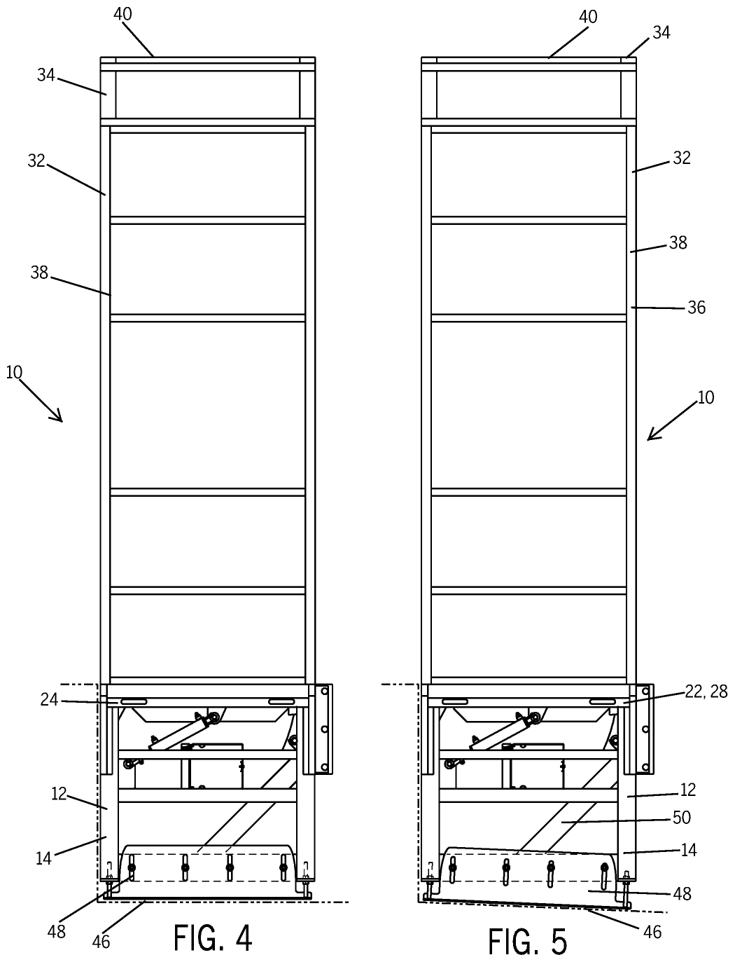

FIGS. 4-6 illustrate that mobile base 12 has at least two, opposing adjustable plates 48, and each plate 48 is located between two adjustable feet 44. Adjustable plate 48 has a portion of each end which is sandwiched between two adjustable feet which are located on adjustable leg member 14, as seen in FIGS. 2-3. A bolt with two nuts secures adjustable plate 48 in between two adjustable feet 44, as seen in FIGS. 2-3. Each adjustable plate 48 includes one or more securement structures. The securement structures have a bolt 60 and at least one or two nuts 62 to secure bolt 60 in the desired position.

Adjustable leg members 14 can be adjusted to conform to grade 46 by first loosening nuts 62 on each adjustable plate 48. Preferred embodiments of mobile base 12 will include two opposing adjustable plates 48. Nuts 62 must be loosened on each adjustable plate 48. Preferred embodiments include four adjustable leg members on each mobile base 12. Next, first locking nut 54 and second locking nut 56 on each of the four adjustable leg members 14 must be loosened. Loosening first locking nut 54 and second locking nut 56 allows the height of each of the adjustable feet 44 to be adjusted so that it contacts the grade 46. Each adjustable leg member 14 includes two adjustable feet 44. A mobile base will therefore, have eight adjustable feet 44 in all. Once each of the eight adjustable feet 44 are contacting grade 46, first locking nut 54 and second locking nut 56 can be tightened on each adjustable leg member 14. At the same time each nut 62 on adjustment plate 48 can be tightened as well.

FIGS. 4-5 illustrate that adjustable plate 48 also shifts with grade 46. FIG. 4 illustrates adjustable plate 48 in a relatively horizontal position. In contrast, FIG. 5 illustrates that adjustable plate 48 is in an angled position (in a direction angled down to the right of the drawing) showing that adjustable plate 48 has conformed to grade 46 with adjustable feet 44. A brace member 50 is connected to adjustable plate 48 on one end and provides added strength to mobile base 12, as seen in FIGS. 4-6.

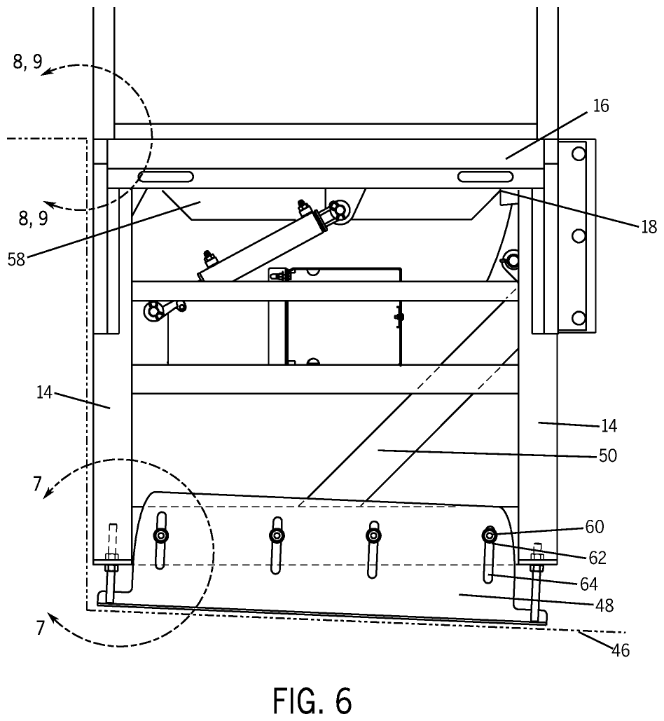

FIG. 6 also illustrates in detail how adjustable plate 48, through the use of bolt 60 and nut 62, can be adjusted. As seen best in FIG. 6, adjustable plate 48 includes numerous slots through which bolt 60 and nut 62 can slide in an upward and downward direction as needed to help adjustable plate 48 conform to grade 46. Once adjustable plate 48 is in the desired position, bolt 60 and nut 62 are secured in place in slot 64 by tightening nut 62. Preferably, there are two nuts 62, one on each side of bolt 60.

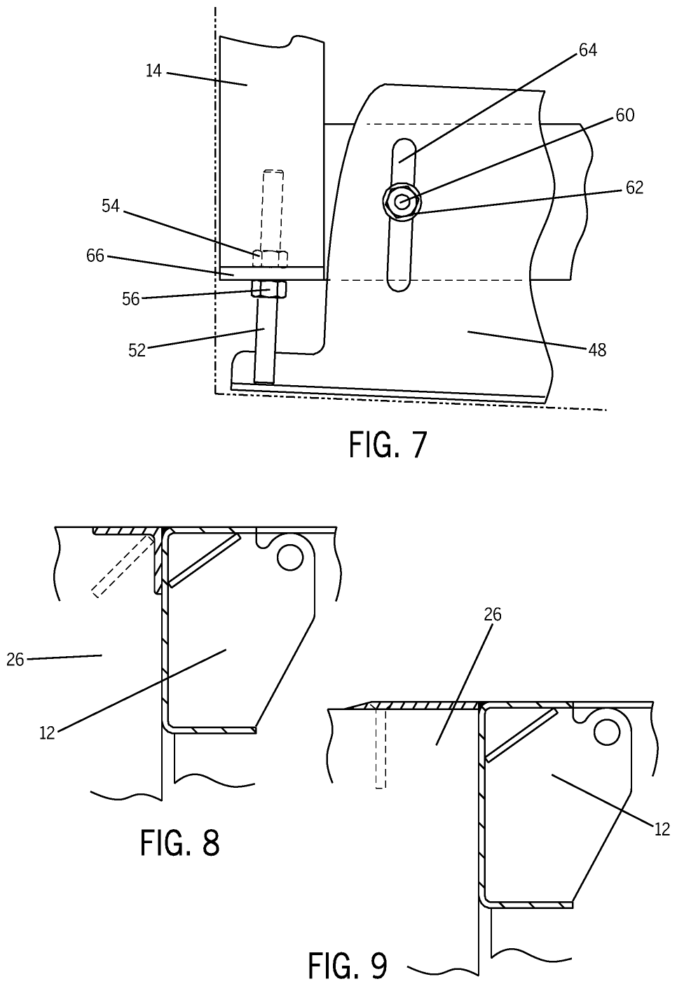

The adjustment of adjustable leg member 14 and adjustable plate 48 is seen in FIG. 7. FIG. 7 also illustrates in close up detail the interaction and adjustability of leg member 14 and adjustable plate 48. First locking nut 54 and second locking nut 56 are each located on locking bolt 52, as seen in FIG. 7. Locking bolt 52 goes through an opening in a lower end 66 of adjustable leg member 14 (see FIG. 7) so as to secure adjustable leg member 14 in the desired position.

It is important to note that each side of base 12 has an adjustment plate 48 and that each adjustment plate 48 on either side of base 12 can be adjusted independently of the other adjustment plate 48 on the other side of base 12. Being able to adjust adjustment plate 48 to the exact contour of grade 46 allows for a more secure attachment to grade 46 and greater stability of base 12. This is also true of each of the four adjustable leg members 14. Each of the four adjustable leg members 14 which are part of base 12 can be adjusted independently of every other adjustable leg member 14.

Base 12 can be secured to any type of ground 36, including but not limited to gravel, asphalt or concrete. It is important to note that base 12 can be secured to ground 36 by any known method and all such methods are within the scope of the application.

FIGS. 8-9 illustrate how base 12 can be secured in different ways to a building or other preexisting structure 26.

The drawings also illustrate that dock leveler 58 has a lower end 22 and an upper end 24 (as seen best in FIGS. 4-5). Upper end 24 abuts a preexisting structure 26 and lower end 24 includes a lower edge 28 which has a lip 30, as seen in FIGS. 4-5. Lip 30 is able to be activated between an extended/engaged position to contact a truck bed and a retracted/disengaged position (not shown).

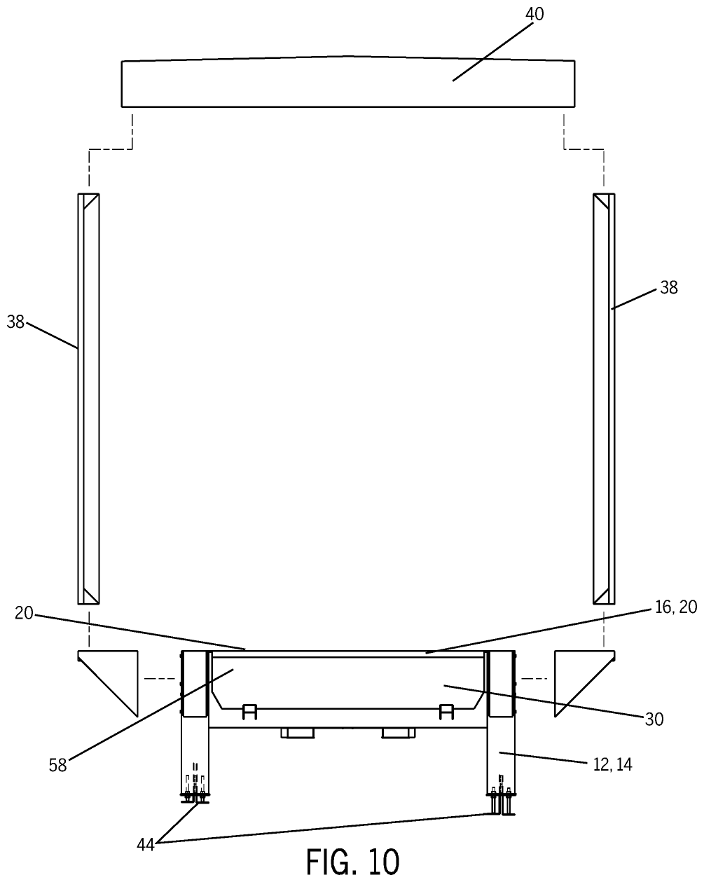

FIG. 10 is an exploded view which illustrates the interaction between housing 32, including frame 34 and mobile base 12. Dock leveler 58 with lip 30 can also be seen in FIG. 10. Frame-top wall 40 as well as opposed frame-sidewalls 38 are also seen in FIG. 10. Housing 32 can be secured to a wall of a pre-existing structure 26. (See FIG. 1.) Base 12 and housing 32 are removable and able to be transported to different locations.

A lifting system is incorporated into dock leveler 58. The hydraulic lifts assist in lifting a section of dock leveler 58. However, any other lifting systems known in the art could be utilized as well. A variety of dock levelers of different sizes and shapes can be used and are within the scope of this application

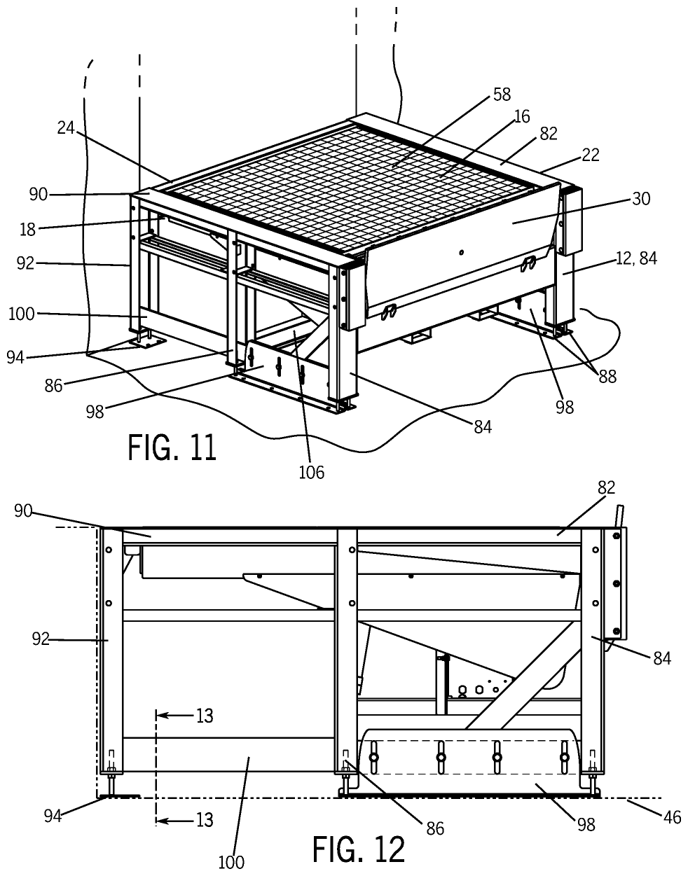

FIGS. 11-12 illustrate that modular loading dock 10 can include mobile base 12 with an adjustable front section 82 which has front opposing adjustable leg members 84 and middle opposing adjustable leg members 86. Two adjustable feet 88 connect each front leg member 84 to a middle leg member 86. FIGS. 11-12 also illustrate that an adjustable back section 90 is connected to adjustable front section 82 and includes opposing rear adjustable leg members 92, each of which has a grade plate 94. Mobile base 12, as seen in FIGS. 11-12, has top 16 and bottom 18 surfaces. Top surface 16 has an opening 20 to receive a dock leveler 58 into such opening 20. The dock leveler shown in FIGS. 11-12 includes a lower end 22 and an upper end 24. Upper end 24 abuts a preexisting structure 26 and lower end 22 includes a lower edge 28 which has a lip 30. Lip 30 can be activated between an extended/engaged position to contact a truck bed and a retracted/disengaged position.

FIGS. 11-12 illustrate that a unitary support member 100 is connected to each opposing front adjustable leg member 84, middle adjustable leg member 86 and rear adjustable leg member 92. Opposing unitary support members 100 are present on each side of mobile base 12 and connect each opposing front adjustable leg member 84, middle adjustable leg member 86 and rear adjustable leg member 92. On each side of mobile base 12, adjustable plate 98 is secured to unitary support member 100 by the locking bolt 52, first locking nut 54 and second locking nut 56, as seen in FIGS. 11-12. Mobile base 12 also includes a cross support member 106 which connects the two opposed middle adjustable leg members 86, as can be seen best in FIG. 11. Cross support member 106 adds strength and rigidity to mobile base 12. Several other support members can be added to mobile base 12 between various components to increase strength and rigidity. For example, support members can be added between front opposing leg members 84 and unitary support member 100, or between each front opposing leg member 84 and middle opposing leg member 86, or even rear opposing leg members 92. Mobile base 12 has a great resistance to trailer or vehicle impact. The at least two adjustable feet 88 contact and conform to grade 46, as seen in FIGS. 12 and 14. Adjustable feet 88 are able to be adjusted between a left-side to right-side direction as well as adjustable in a front-to-back direction so as to allow the two adjustable feet to conform to grade 46.

FIG. 14 illustrates that adjustable feet 88 are able to be adjusted independently of each other and that they can conform to grade 46. In FIG. 14, opposing front 84 and middle adjustable leg members 86 at a distal end each include one or more adjustment structures 96. Adjustment structures 96 are connected to the adjustable feet 88 and having an adjustable plate 98, locking bolt, a first locking nut and a second locking nut. (Locking bolt 52, first locking nut 54 and second locking nut 56 are shown in detail in FIGS. 2-3). Adjustable plate 98 is seen best in FIGS. 11-12 and 14. Locking bolt, first locking nut and second locking nut can be seen in a close up in FIGS. 2-3.

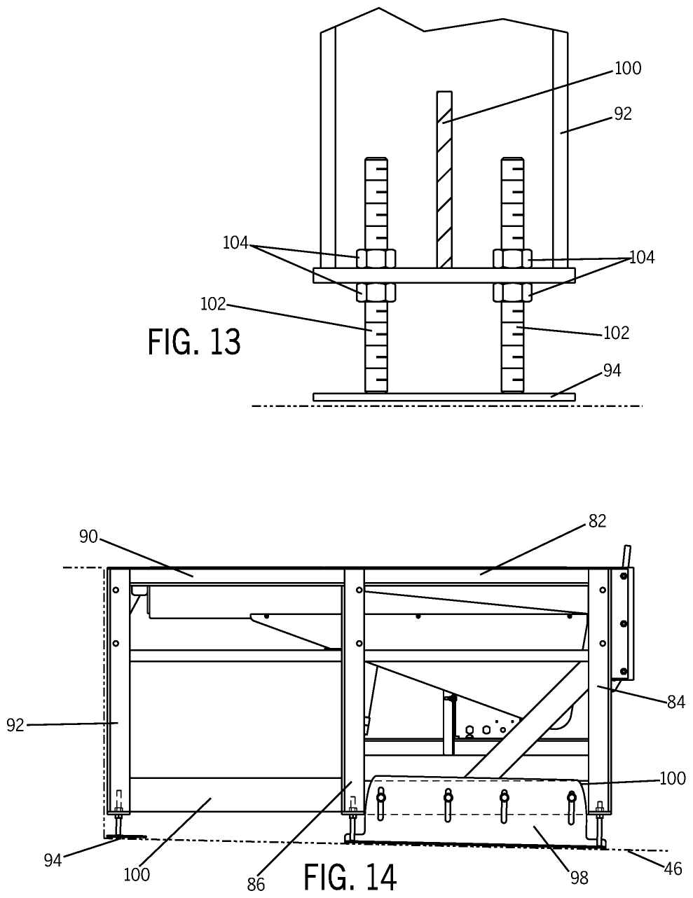

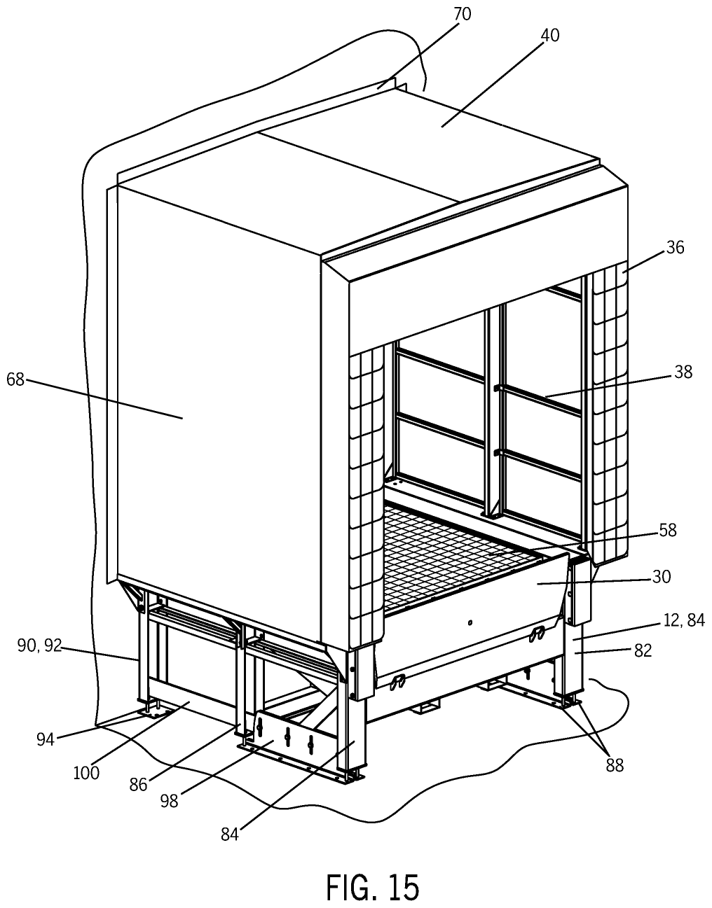

Rear adjustable leg members, shown best in FIGS. 11 and 15, include one or more rear adjustment structures 102 with one or more rear locking nuts 104. FIG. 13 illustrates in detail rear adjustment structures 102 and four rear locking nuts 104. Rear adjustment structures 102 can be set at varying heights. Once the preferred height is reached, then rear locking nuts 104 are tightened to hold read adjustment structure 102 in place. One or more rear adjustment structures 102 can be used. Additionally, two opposing grade plates 94, each on opposing rear adjustable leg members 92, are able to be adjusted independently of each other. That is, one grade plate 94 on one side can be set at a higher or lower level than the grade plate 94 on the opposing side. This helps to keep mobile base 12 level on uneven surfaces. This allows mobile base 12 to have substantial adjustability so as to conform to all types of grades. As seen in FIG. 15, some embodiments include housing 32 with modular frame 34 mounted onto base 12 in sections. Housing 32 includes a frame-front wall 36, opposed frame-sidewalls 38 and a frame-top wall 40. Frame-front wall 36 has an opening 42 to receive a back end of a vehicle to facilitate loading and unloading of cargo.

Modular frame 34 includes a covering 68, as seen in FIG. 15. Covering 68 is typically made of a tensioned vinyl. Flashing, including a flashing bar 70, helps to attach tensioned vinyl covering 68 to a building.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A modular loading dock comprising a mobile base including (a) an adjustable front section having front opposing adjustable leg members and middle opposing adjustable leg members, two adjustable feet connect each front leg member to a middle leg member; (b) an adjustable back section connected to the adjustable front section and including opposing rear adjustable leg members each having a grade plate; and (c) top and bottom surfaces, the top surface having an opening to receive a dock leveler into such opening, the dock leveler including a lower end and an upper end, the upper end abutting a preexisting structure and the lower end including a lower edge having a lip, the lip being able to be activated between an extended/engaged position to contact a truck bed and a retracted/disengaged position.

2. The modular loading dock of claim 1 wherein the at least two adjustable feet contact and conform to the grade.

3. The modular loading dock of claim 2 wherein the at least two adjustable feet are able to be adjusted independently of each other.

4. The modular loading dock of claim 2 wherein the at least two adjustable feet are able to be adjusted between a left-side to right-side direction as well as adjustable in a front-to-back direction so as to allow the two adjustable feet to conform to the grade.

5. The modular loading dock of claim 1 wherein the opposing front and middle adjustable leg members at a distal end each include one or more adjustment structures, the adjustment structures being connected to the adjustable feet and having an adjustable plate, locking bolt, a first locking nut and a second locking nut.

6. The modular loading dock of claim 5 further including a unitary support member connected to each opposing front adjustable leg member, middle adjustable leg member and rear adjustable leg member.

7. The modular loading dock of claim 6 wherein the adjustable plate is secured to the support member by the locking bolt, first locking nut and second locking nut.

8. The modular loading dock of claim 2 wherein the two opposing grade plates are able to adjust independently of each other.

9. The modular loading dock of claim 1 wherein the opposing rear adjustable leg members include one or more rear adjustment structures, the rear adjustment structures including one or more rear locking nuts.

10. The modular loading dock of claim 1 wherein the mobile base is removable and able to be transported to different locations.

11. A modular loading dock comprising:
X a mobile base including (a) an adjustable front section having a first opposing adjustable leg members and second opposing adjustable leg members, each first and second leg members including at least two adjustable feet, each adjustable foot connecting a first leg member to a second leg member; (b) an adjustable back section connected to the adjustable front section and including opposing rear adjustable leg members; and (c) top and bottom surfaces, the top surface having an opening to receive a dock leveler into such opening, the dock leveler including a lower end and an upper end, the upper end abutting a preexisting structure and the lower end including a lower edge having a lip, the lip being able to be activated between an extended/engaged position to contact a truck bed and a retracted/disengaged position; and
X a housing consisting of a modular frame mounted onto the base in sections, such sections including a frame-front wall, opposed frame-sidewalls and a frame-top wall, the frame-front wall having a vehicle-receiving opening to receive a back end of a vehicle, the modular frame including a covering.

12. The modular loading dock of claim 11 wherein the covering is a tensioned vinyl covering.

13. The modular loading dock of claim 12 further including flashing being integral to the tensioned vinyl covering.

14. The modular loading dock of claim 11 wherein the housing is secured to a wall of a building.

15. The modular loading dock of claim 11 wherein the base and housing are removable and able to be transported to different locations.

16. The modular loading dock of claim 11 wherein the at least two adjustable feet contact and conform to the grade.

17. The modular loading dock of claim 16 wherein the at least two adjustable feet are able to be adjusted independently of each other.

18. The modular loading dock of claim 16 wherein the at least two adjustable feet are able to be adjusted between a left-side to right-side direction as well as adjustable in a front-to-back direction so as to allow the two adjustable feet to conform to the grade.

19. The modular loading dock of claim 11 wherein the opposing front and middle adjustable leg members at a distal end each include one or more adjustment structures, the adjustment structures being connected to the adjustable feet and having an adjustable plate, locking bolt, a first locking nut and a second locking nut.

20. The modular loading dock of claim 19 further including a unitary support member connected to each opposing front adjustable leg member, middle adjustable leg member and rear adjustable leg member.

21. The modular loading dock of claim 20 wherein the adjustable plate is secured to the support member by the locking bolt, first locking nut and second locking nut.

22. The modular loading dock of claim 11 wherein the opposing rear adjustable leg members include one or more rear adjustment structures, the rear adjustment structures including one or more rear locking nuts.

23. The modular loading dock of claim 11 further including a cross support member connecting the two opposed middle adjustable leg members.
